(19) United States
(12) Patent Application Publication
(10) Pub. No.: US 2019/0305603 A1
(43) Pub. Date: Oct. 3, 2019

(54) METHOD FOR DESIGNING SIGNAL WAVEFORMS

(71) Applicant: IMPERIAL COLLEGE INNOVATIONS LIMITED, London (GB)

(72) Inventor: Bruno CLERCKX, London (GB)

(21) Appl. No.: 16/346,527

(22) PCT Filed: Nov. 1, 2017
(86) PCT No.: PCT/GB2017/053285

§ 371 Date: Apr. 30, 2019

(30) Foreign Application Priority Data
Nov. 1, 2016 (GB) 1618442.6

(51) Int. Cl. H02J 50/20; H02J 50/40; H04B 5/00

(52) U.S. Cl. CPC H02J 50/20; H04B 5/0037; H02J 50/40

(57) ABSTRACT

The disclosure concerns a WPT link optimization and discloses a method for designing low-complexity multisine waveforms for WPT. Assuming the CSI is available to the transmitter, the waveforms are expressed as a scaled matched filter and shown through realistic simulations to achieve performance very close to the optimal waveforms that would result from a non-convex posynomial maximization problem. Given the low complexity of the design, the proposed waveforms are very suitable for practical implementation.

### FIELD

The present disclosure relates generally to far-field Wireless Power Transfer (WPT) and, in particular, to the waveform design of input waveforms used in rectenna radio frequency to direct current (RF-to-DC) conversion during WPT.

### BACKGROUND

WPT via radio-frequency radiation has a long history that is nowadays attracting more and more attention. RF radiation has indeed become a viable source for energy harvesting with clear applications in Wireless Sensor Networks (WSN) and an Internet of Things (IoT). The major challenge facing far-field wireless power designers is to find ways to increase the DC power level at the output of the rectenna without increasing the transmit power, and for devices located tens to hundreds of meters away from the transmitter. To that end, the vast majority of the technical efforts in the literature have been devoted to the design of efficient rectennas, as for example in H. J. Visser, R. J. M. Vullers, “RF Energy Harvesting and Transport for Wireless Sensor Network Applications: Principles and Requirements,” Proceedings of the IEEE, Vol. 101, No. 6, June 2013. ([1] henceforth).

A rectenna harvests ambient electromagnetic energy, then rectifies and filters it (using a diode and a low pass filter). The recovered DC power then either powers a low power device directly, or is stored in a super capacitor for higher power low duty-cycle operation.

Interestingly, the overall RF-to-DC conversion efficiency of the rectenna is not only a function of its design but also of its input waveform. The problem of multisine waveform design for wireless power transfer has recently been tackled in B. Clerckx, E. Bayguzina, D. Yates, and P. D. Mitcheson, “Waveform Optimization for Wireless Power Transfer with Nonlinear Energy Harvester Modeling,” IEEE ISWCS 2015 ([2] henceforth) and B. Clerckx and E. Bayguzina, “Waveform Design for Wireless Power Transfer” IEEE Trans on Sig Proc arXiv:1604.00074 ([3] henceforth) and further extended in Y. Huang and B. Clerckx, “Waveform Optimization for Large-Scale Multi-Antenna Multi-Sine Wireless Power Transfer,” IEEE SPAWC 2016, arXiv:1605.01191 ([4] henceforth) for large scale WPT architecture.

The authors of the referenced literature derived a formal methodology to design WPT waveforms. Gains over various baseline waveforms have been shown to be very significant. Unfortunately, those waveforms do not lend themselves to practical implementation because they result from a non-convex optimization problem. This is a computationally intensive optimization problem that would require to be solved real-time as a function of the channel state information (CSI), by finding terms numerically through numerical optimization methods. The CSI, as known in the art, is the response in terms of the amplitude and phase of a frequency propagation channel, which changes as an EM wave propagates through space due to scattering and reflection effects. It is the complex domain representation of the propagation channel.

It would be desirable, therefore, to have a method for designing less complex and computationally intensive waveforms that nevertheless come close to the benchmarks set by the optimal waveforms produced by the computationally intensive methods of cited documents [2], [3] and [4].

### SUMMARY

According to an aspect of the present disclosure, a method of transmitting a multicarrier signal comprising N carriers from at least one transmitter to at least one rectenna in a Wireless Power Transfer (WPT) system is disclosed, wherein the method comprises generating the multicarrier signal for transmission by the at least one transmitter and wherein the generating the signal comprises: specifying an amplitude, sₙ, of an nₜₕ carrier of the N carriers, wherein the amplitude, sₙ, of the nₜₕ carrier is specified based on a frequency response of a channel associated with the nₜₕ carrier; and transmitting the signal. Each carrier may be considered a signal of the multicarrier signal.

The wireless propagation channel, or “channel”, is characterized by its impulse response that changes dynamically due to mobility and following reflection, diffraction, diffusion on surrounding scatterers. The frequency response of the channel is the Fourier Transform of the impulse response. In layman's terms, the frequency response of the channel on frequency n is the response of the wireless propagation channel in amplitude and phase to a single frequency signal transmitted on frequency n.

The amplitude, sₙ, of the nₜₕ carrier may be proportional to the frequency response of the channel associated with the nₜₕ carrier.

The amplitude, sₙ, of the nₜₕ carrier may be proportional to the frequency response of the channel associated with the nₜₕ carrier scaled by an exponent factor. The exponent factor may be a pre-determined constant. The exponent factor may be selected from a range of values greater than or equal to 0.5. The exponent factor may be selected from a range of values greater than or equal to 1. The exponent factor may be selected from a range of values between 0.5 and 5. The exponent factor may be selected from a range of values between 1 and 3.

The amplitude, sₙ, of the nₜₕ carrier may be specified in accordance with:

sₙ=cAₙ^{β}

where c is a constant, β is the exponent factor and Aₙ is a magnitude of the frequency response of a channel associated with the nₜₕ sinewave.

In some embodiments, β may be a solution of an unconstrained optimisation problem.

β may be defined as:

β=argmaxβz_{DC},SMF

where argmax_{β}z_{DC},SMF denotes that the argument that maximizes z_{DC},SMF, i.e. the value of β that leads to the maximum value of the objective function z_{DC},SMF is provided.

More generally, β may be either fixed or optimized on a per channel basis so as to maximize the output DC power/current/voltage.

c may satisfy a transmit power constraint given by:

½Σₙ₌₀^{N-1}sₙ²=P

where P is the transmit power.

In some embodiments, β may be fixed or optimized on a per channel basis.

In some embodiments, the multicarrier signal comprising N carriers may be transmitted from a plurality of transmitters, wherein the plurality of transmitters optionally comprises a plurality of antennas.

The multicarrier signal comprising N carriers may be transmitted from a plurality of transmitters, wherein the plurality of transmitters optionally comprises a plurality of antennas.

Where a multicarrier signal is to be transmitted from a plurality of transmitters, the amplitude of the signal on carrier n may be proportional to the frequency response of the vector channel associated with the nth carrier. Additionally, the amplitude, sₙ, of the n^{th} carrier may be proportional to the norm of frequency response of the vector channel associated with the n^{th} carrier scaled by an exponent factor.

In some embodiments, the multicarrier signal comprises a multisine signal comprising N sinewaves.

According to an aspect of the present disclosure, at least one transmitter for transmitting signals to at least one rectenna in a Wireless Power Transfer (WPT) system is disclosed, the at least one transmitter comprising a processing environment configured to perform any of the above methods.

The transmitter may comprise a plurality of transmitters, wherein the plurality of transmitters optionally comprises a plurality of antennas.

The present disclosure relates to a method for identifying a set of amplitudes and phases of signals that produce a near-optimal time average of a current of a diode, iₒᵤₜ. The time average may be a measure of a DC current at an output of a rectenna receiving the signals and the diode may be part of the rectenna.

Maximising iₒᵤₜ may be equivalent to maximising z_{DC}. z_{DC} is the contribution to the DC current iₒᵤₜ that is a function of the input signal. z_{DC} can be considered the component of the diode current that is affected by the design of the waveform of the input signal transmitted by the transmitter. The remaining contributions to iₒᵤₜ are those which are constants that are not affected by the design of the input signal, which can be disregarded for the purposes of optimizing waveform design.

z_{DC} may be expressed, for any input signal y(t), as:

Z_{DC}(s,Φ)=k₂Rₐₙₜε{y(t)²}+k₄Rₐₙₜ²ε{y(t)⁴}

where s is a vector magnitudes of the signals, Φ is a vector of the phases of the signals and Rₐₙₜ is a series resistance of a lossless antenna.

$${k}_{i} = \frac{{i}_{s}}{i ! {( {nv}_{t} )}^{i}} ,$$

where iₛ is the reverse bias saturation current, νₜ is the thermal voltage, n is the ideality factor that may be assumed equal to 1.05 and a is a quiescent operating point equal to the voltage drop across the diode, vd.

By assuming that the input signal, y(t), is written as a multisine signal passing through a frequency selective channel, z_{DC} may be written as:

$${Z}_{D C} ( s , Φ ) = \frac{{k}_{2}}{2} {R}_{ant} [ {\sum }_{n = 0}^{N - 1} {s}_{n}^{2} {A}_{n}^{2} ] + \frac{3 {k}_{4}}{8} {R}_{ant}^{2} [ {\sum }_{{{n}_{0} , {n}_{1} , {n}_{2} , {n}_{3}}_{{n}_{0} + {n}_{1} = {n}_{2} + {n}_{3}}} [ {\prod }_{j = 0}^{3} {s}_{{n}_{j}} {A}_{{n}_{j}} ] cos ( {ψ}_{{n}_{0}} + {ψ}_{{n}_{1}} - {ψ}_{{n}_{2}} - {ψ}_{{n}_{3}} ) ]$$

where sₙ is the amplitude of the n^{th} sinewave of the transmitted multisine signal at frequency fₙ. Aₙ is a magnitude of a frequency response of a channel on frequency fₙ and ψₙ is a phase of a frequency response of a channel on frequency fₙ. The transmitted multisine signal is different from the received multisine signal at the input of the rectenna because of the wireless channel that changes the magnitudes and phases of each frequency component of the transmitted multisine signal.

z_{DC} may be subject to the transmit power constraint ½∥s∥_{F}²≤P where P is the transmit power. If an array of antennas is used at the transmitter, s is a matrix that contains a magnitude of the signals allocated over multiple frequencies and multiple transmit antennas.

There may be one or more transmitter antennas and one or more receiver antennas. A complex weight given to a signal may be written as w_{n,m}=ce^{-jα}^{_{n,m}}χ_{n,m}^{β} where c is a constant that accounts for the total transmit power constraint, α_{n,m} is a phase on sinewave n and antenna m, x_{n,m} is a function of the wireless channel(s) on sinewave n and transmit antenna m and β is a scalar≥1. Equivalently, this can be viewed as performing maximum ratio transmission across the spatial domain on each frequency and allocating power on each sinewave/frequency by replacing Aₙ with the norm of the vector channel.

There may be a single transmit antenna and a single receive antenna.

In the case of a single transmit antenna and a single receive antenna, x_{n,m} may simplify to χ_{n,m}=χₙ. χₙ may be chosen as χₙ=Aₙ.

According to an implementation of the present disclosure, the amplitudes of the sinewaves of the multisine signal may be selected by the equation:

sₙ=cAₙ^{β}

such that the amplitude of the nth sinewave, sₙ, is proportional to Aₙ^{β}, wherein β is a real scalar≥1 and c is a constant which satisfies the transmit power constraint ½Σₙ₌₀^{N-1}sₙ²≤P where N is the number of sinewaves in the multisine signal.

The phases of the sinewaves may be selected such that ϕₙ=−ψ̅ₙ, where ψ̅ₙ is a phase of a frequency response of a channel on frequency n. The transmit phases ϕₙ may be chosen such that all signals arrive in-phase at the input of the rectenna.

sₙ may be combined with ϕₙ, such that a complex weight on signal n of a scaled matched filter (SMF) waveform is given in closed form by the equation:

$${w}_{n} = {s}_{n} {e}^{j {φ}_{n}} = {e}^{- j {\overline{ψ}}_{n}} {A}_{n}^{β} \sqrt{\frac{2 P}{{\sum }_{n = 0}^{N - 1} {A}_{n}^{2 β}}}$$

wherein the complex weight contains real and imaginary parts of magnitudes and phases. The complex weight may dictate the magnitude and phases assigned to the signals generated by the transmitter. A higher magnitude may be allocated to frequencies exhibiting larger channel gains. Hence if Aₙ is large, sₙ will be large. If Aₙ is small, sₙ is small. An advantageous result of the disclosed method is therefore that strong frequency components are amplified and weak frequency components are attenuated, which is desirable.

The SMF waveform design may be arranged such that β=1, whereby sₙ is linearly proportional to Aₙ and the SMF waveform exhibits matched filter (MF), or maximum ratio transmission (MRT), like behavior.

Alternatively, the SMF waveform design may be arranged such that β>1, such that strong frequency components are amplified and weak ones are attenuated. Alternatively, the SMF waveform design may be arranged such that β≥0.5. Alternatively, the SMF waveform design may be arranged such that β≥1.

Alternatively, the SMF waveform design may be arranged such that β is between 0.5 and 5 inclusive. Alternatively, the SMF waveform design may be arranged such that β is between 1 and 3 inclusive.

The SMF waveform design may be alternatively arranged such that, for a given channel realisation or time instant, β is a solution of the unconstrained optimisation problem β*=arg max_{β} Z_{DC,SMF}. The unconstrained optimisation problem finds the value of β that maximises z_{DC} when using the SMF waveform strategy. This may be solved via Newton's method which finds the roots or zeroes of a function.

### BRIEF DESCRIPTION OF FIGURES

FIG. 1 shows an antenna equivalent circuit (left) and a single diode rectifier (right);

FIG. 2 shows the frequency response of the wireless channel and WPT waveform magnitudes (N=16) for 10 MHz bandwidth;

FIG. 3 shows a rectenna with single series (top), voltage doubler (centre) and diode bridge rectifier (bottom); and

FIG. 4 shows Average z_{DC} and average DC power delivered to the load as a function of N for various rectifiers.

### DETAILED DESCRIPTION

The present disclosure is generally directed at a design of multi-sine waveforms. In order to provide improved functionality, the signal waveforms should adapt as the amplitude and phase of the frequency response of the channel changes dynamically. This dynamic changing occurs as a result of scattering and reflection effects as the signal propagates. In other words, the disclosure relates to a method of designing signal waveforms that are adaptive to the CSI, whose performance is very close to the optimal design of [2], [3] but whose complexity is significantly lower than the methods set out in those documents. Previous methodologies utilize computationally intensive numerical optimization methods to achieve optimized results. The present disclosure on the other hand presents a WPT link optimization and derives a methodology to design low complexity multisine waveforms for WPT by expressing the waveforms as a scaled matched filter (SMF). This method assumes that the CSI is available to the transmitter, which is a reasonable assumption in practice. As will be demonstrated in section D below, it has been shown through realistic simulations that the disclosed SMF method achieves performance very close to the optimal waveforms that would result from a non-convex posynomial maximization problem.

Given the low complexity of the disclosed design, the proposed waveforms are very suitable for practical implementation. Further, the proposed waveform design results from a simple SMF that has the effect of allocating more power to the frequency components corresponding to large channel gains and less power to those corresponding to weak channel gains, which is desirable.

The disclosed method will now be described in detail. First, a system model will be introduced, followed by waveform design. The performance of the waveforms produced by the disclosed method will then be described. Bold letters stand for vectors or matrices whereas a symbol not in bold font represents a scalar. |.| and ∥.∥ refer to the absolute value of a scalar and the 2-norm of a vector. ε {.} refers to the averaging operator.

First, a WPT system model will be described in detail. The disclosure initially comprises for simplicity a point to point wireless power transfer with a single transmit and receive antenna, however the waveform design proposed can easily be extended to a more general setup with multiple transmit antennas and one or more multiple receiver antennas.

### A. Received Signal

Consider the simple arrangement comprising a single transmit and receive antenna further comprising a multisine signal (with N sinewaves) transmitted at time t,

$$x ( t ) = \{ {\sum }_{n = 0}^{N - 1} {w}_{n} {e}^{j 2 π {f}_{n} t} \} \qquad ( 1 )$$

with wₙ=sₙe^{jϕ}^{ₙ} where j²=−1 and sₙ and ϕₙ refer to the amplitude and phase of the nth sinewave at frequency fn, respectively. It is assumed for simplicity that the frequencies are evenly spaced, i.e. fₙ=fₒ+nΔ_{f} with Δ_{f} the frequency spacing. The magnitudes and phases of the sinewaves can be collected into vectors s and Φ. The nth entry of s and Φ writes as sₙ and ϕₙ, respectively. The transmitter is subject to a transmit power constraint ε{|x|²}=½∥s∥_{F}²≤P where P is the transmit power and F is refers to the Frobenius norm of a vector/matrix.

The transmitted sinewaves propagate through a multipath channel, characterized by L paths whose delay, amplitude and phase are respectively denoted as τₗ, αₗ, ξₗ, l=1, . . . , L. The signal received at the single-antenna receiver after multipath propagation can be written as

$$\begin{matrix}y ( t ) = {\sum }_{n = 0}^{N - 1} {\sum }_{l = 0}^{L - 1} {s}_{n} {α}_{l} cos ( 2 π {f}_{n} ( t - {τ}_{l} ) + {ξ}_{l} + {φ}_{n} ) & \\ = {\sum }_{n = 0}^{N - 1} {s}_{n} {A}_{n} cos ( 2 π {f}_{n} t + {ψ}_{n} ) & ( 2 ) \\ = \{ {\sum }_{n = 0}^{N - 1} {h}_{n} {w}_{n} {e}^{j 2 π {f}_{n} t} \} & ( 3 )\end{matrix}$$

where hₙ=Aₙe^{jψ̅}^{ₙ}=Σₗ₌₀^{L-1}αₗe^{j(-2πf}^{ₙ}^{τ}^{ₗ}^{+ξ}^{ₗ}⁾ is the channel frequency response at frequency fₙ. The amplitude Aₙ and the phase ψₙ are such that Aₙe^{jψ}^{ₙ}=Aₙe^{j(ϕ}^{ₙ}^{+ψ̅}^{ₙ}⁾=e^{jϕ}^{ₙ}hₙ.

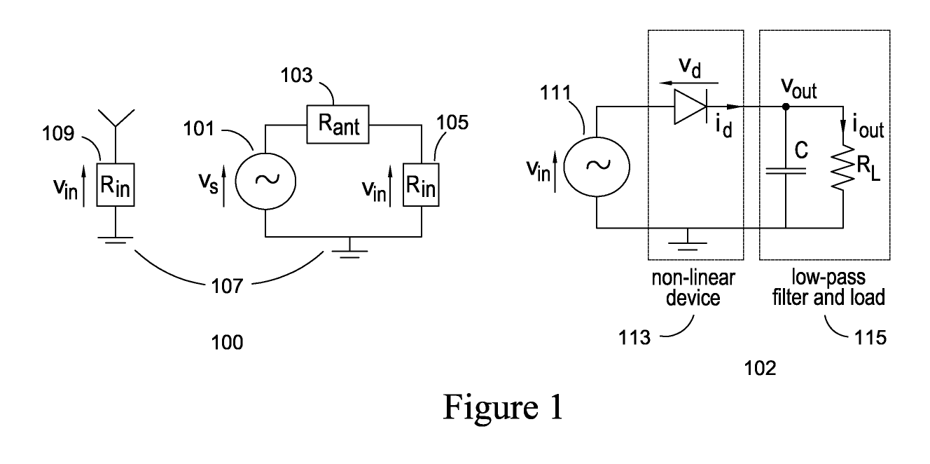

The antenna model reflects the power transfer from the antenna to the rectifier through the matching network. FIG. 1 shows an antenna equivalent circuit (100) and a single diode rectifier (102) of the sort that may be used when implementing the disclosed method. As illustrated in FIG. 1, a lossless antenna can be modelled as a voltage source νₛ(t) (101) followed by a series resistance Rₐₙₜ (103). Also depicted are input impedances of the rectifier (105) and (109), grounds (107) and an equivalent voltage source of the rectifier (111). Let Zᵢₙ=Rᵢₙ+jXᵢₙ denote the input impedance of the rectifier with the matching network. Assuming perfect matching (Rᵢₙ Rₐₙₜ, Xᵢₙ=0), all the available RF power P_{in,av} is transferred to the rectifier and absorbed by Rᵢₙ, so that P_{in,av}=ε(|νᵢₙ(t)|²)/Rᵢₙ and νᵢₙ(t)=νₛ(t)/2. Since P_{in,av}=ε{|y(t)|²}, νₛ(t) can be formed as

νₛ(t)=2y(t)\sqrt{Rᵢₙ}=2y(t)\sqrt{Rₐₙₜ}. (4)

### B. Rectifier and Diode Non-Linear Model

Consider a rectifier composed of a single series diode followed by a low-pass filter with load as in FIG. 1. Denoting the voltage drop across the diode as ν_{d}(t)=νᵢₙ(t)−νₒᵤₜ(t) where νᵢₙ(t) is the input voltage to the diode and νₒᵤₜ(t) is the output voltage across the load resistor, a tractable behavioral diode model is obtained by Taylor series expansion of the diode characteristic equation

$${i}_{d} ( t ) = {i}_{s} ( {e}^{\frac{{v}_{d} ( t )}{{nv}_{t}}} - 1 )$$

(with iₛ the reverse bias saturation current, νₜ the thermal voltage, n the ideality factor assumed equal to 1.05) around a quiescent operating point ν_{d}=α, namely

$${i}_{d} ( t ) = {\sum }_{i = o}^{∞} {{k}_{i}^{′} ( {v}_{d} ( t ) - a )}^{i} \qquad ( 5 )$$

where

$${k}_{0}^{′} = {i}_{s} ( {e}^{\frac{a}{{nv}_{t}}} - 1 ) and {k}_{i}^{′} = {i}_{s} \frac{{e}^{\frac{a}{{nv}_{t}}} .}{i ! {( {nv}_{t} )}^{i}} , i = 1 , … , ∞ .$$

Assume a steady-state response and an ideal low pass filter such that νₒᵤₜ(t) is at constant DC level. Choosing α=ε{ν_{d}(t)}=−νₒᵤₜ, (5) can be simplified as

$${i}_{d} ( t ) = {\sum }_{i = o}^{∞} {k}_{i}^{′} {{v}_{i n} ( t )}^{i} = {\sum }_{i = o}^{∞} {k}_{i}^{′} {R}_{ant}^{i / 2} {y ( t )}^{i} . \qquad ( 6 )$$

Truncating (6) to order 4, the DC component of i_{d}(t) is the time average of the diode current, and is obtained as iₒᵤₜ≈k₀′+k₂′ε{y(t)²}+k₄′Rₐₙₜ²ε{y(t)⁴}.

### C. A Low-Complexity Waveform Design

Assuming the CSI (in the form of frequency response hₙ) is known to the transmitter, we aim at finding the set of amplitudes and phases s, Φ that maximizes iₒᵤₜ. Following [3], this is equivalent to maximizing the quantity

Z_{DC}(s,Φ)=k₂Rₐₙₜε{y(t)²}+k₄Rₐₙₜ²ε{y(t)⁴} (7)

where

$${k}_{i} = \frac{{i}_{s}}{i ! {( {nv}_{t} )}^{i \cdot }} ,$$

Assuming iₛ=5 μA, a diode ideality factor n=1.05 and νₜ=25.86 mV, typical values of those parameters for second and fourth order are given by k₂=0.0034 and k₄=0.3829.

The waveform design problem can therefore be written as

_{s,Φ}^{max}z_{DC}(s,Φ) subject to ½∥s∥_{F}²≤P. (8)

where z_{DC} can be expressed as in (9) after plugging the received signal y(t) of (2) into (7).

$${z}_{D C} ( s , Φ ) = \frac{{k}_{2}}{2} {R}_{ant} [ {\sum }_{n = 0}^{N - 1} {s}_{n}^{2} {A}_{n}^{2} ] + \frac{3 {k}_{4}}{8} {R}_{ant}^{2} [ {\sum }_{{{n}_{0} , {n}_{1} , {n}_{2} , {n}_{3}}_{{n}_{0} + {n}_{1} = {n}_{2} + {n}_{3}}} [ {\prod }_{j = 0}^{3} {s}_{{n}_{j}} {A}_{{n}_{j}} ] cos ( {ψ}_{{n}_{0}} + {ψ}_{{n}_{1}} - {ψ}_{{n}_{2}} - {ψ}_{{n}_{3}} ) ] . \qquad ( 9 )$$

From [2] and [3], the optimal phases are given by ϕₙ*=−ψ̅ₙ while the optimum amplitudes result from a non-convex posynomial maximization problem which can be recasted as a Reverse Geometric Program and solved iteratively but does not easily lend itself to practical implementation. Interestingly, as noted in [3], the optimized waveform has a tendency to allocate more power to frequencies exhibiting larger channel gains. Motivated by this observation, in accordance with an implementation of the present disclosure a simple and low-complexity strategy is disclosed which generates a suboptimal but practically useful solution to (8). The disclosed method is denoted as scaled matched filter (SMF) and selects the phases as ϕₙ* but chooses the amplitudes of sinewaves according to:

sₙ=cAₙ^{β} (10)

where c is a constant that satisfies the transmit power constraint ½Σₙ₌₀^{N-1}sₙ²≤P and β≥1, P being the transmit power and N being the total number of sinewaves in the multisine signal. It can be seen from (10) that the amplitude of the nₜₕ sinewave, sₙ, is based on a frequency response of the channel associated with the nₜₕ sinewave, and that sₙ is proportional to Aₙ which is itself scaled by an exponent factor β, hence the denotation “scaled matched filter”. Equation (10) is expressed simply and in closed form, making it computationally efficient to calculate. This represents a deviation from previous methods wherein the amplitudes are calculated numerically through computationally intensive numerical methods.

From (10) we find

$$c = \sqrt{\frac{2 P}{{\sum }_{n = 0}^{N - 1} {A}_{n}^{2 β}}} .$$

The complex weight on sinewave n of the SMF waveform is given in closed form as:

$${w}_{n} = {e}^{- j {\overline{ψ}}_{n}} {A}_{n}^{β} \sqrt{\frac{2 P}{{\sum }_{n = 0}^{N - 1} {A}_{n}^{2 β}}} . \qquad ( 11 )$$

The SMF waveform design is only a function of a single parameter, namely β. We note that by taking β=1, we get a matched filter-like behavior, where the amplitude of sinewave n is linearly proportional to Aₙ. This is reminiscent of maximum ratio transmission (MRT) in communication. On the other hand, by scaling Aₙ using an exponent β>1, we advantageously amplify the strong frequency components and attenuate the weak ones. Importantly, this is achieved without the need for complex numerical methods which are more computationally intensive.

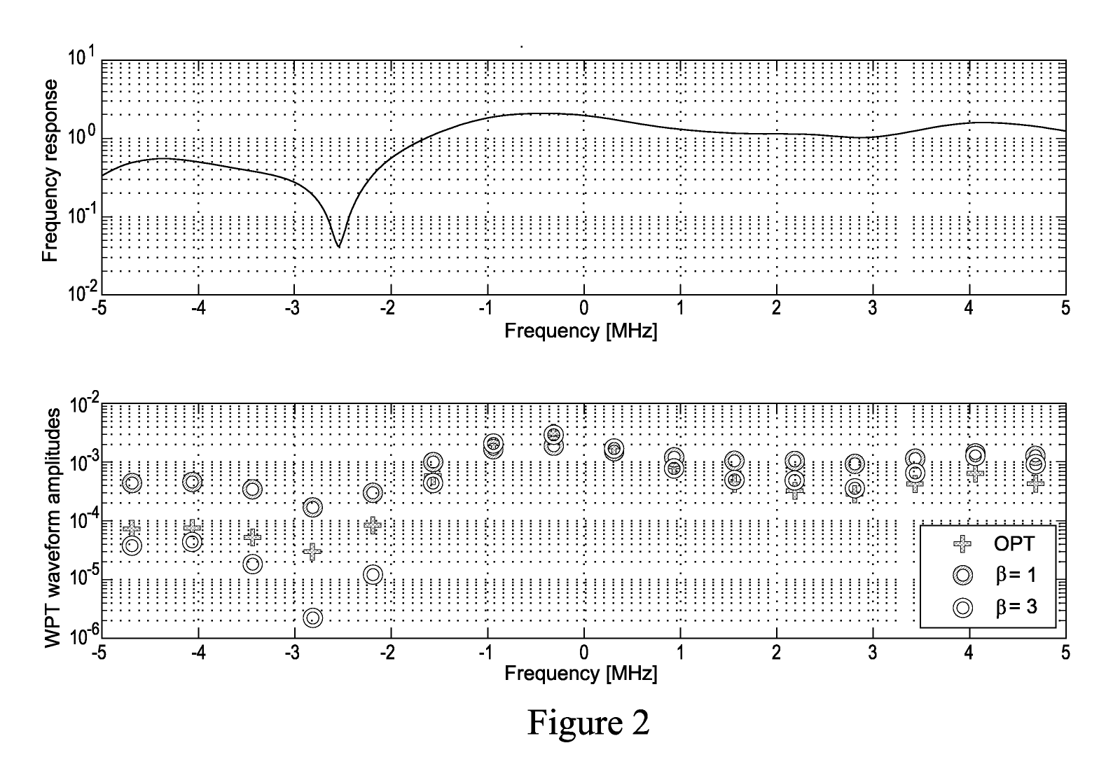

In one implementation, β is set at a pre-determined value. As described above, values of β>1 lead to near optimal results. In practice, values of β in a range of 1-3 inclusive work well. FIG. 2 shows the frequency response of the wireless channel and WPT waveform magnitudes (N=16) for 10 MHz bandwidth. AS can be seen, β=1 and β=3 both perform close to the optimum numerical solution (OPT).

In another implementation, β is optimized on a channel basis. This is achieved by plugging (11) into (9) to yield (12):

$${z}_{D C , SMF} = {k}_{2} {R}_{ant} P [ {\sum }_{n = 0}^{N - 1} \frac{{A}_{n}^{2 ( β + 1 )}}{{\sum }_{n = 0}^{N - 1} {A}_{n}^{2 β}} ] + \frac{3 {k}_{4}}{2} {k}_{4} {R}_{ant}^{2} {P}^{2} [ {\sum }_{{{n}_{0} , {n}_{1} , {n}_{2} , {n}_{3}}_{{n}_{0} + {n}_{1} = {n}_{2} + {n}_{3}}} \frac{{\prod }_{j = 0}^{3} {A}_{{n}_{j}}^{β + 1}}{{[ {\sum }_{n = 0}^{N - 1} {A}_{n}^{2 β} ]}^{2}} ] \qquad ( 12 )$$

For a given channel realization, the optimised β can then be obtained as the solution of the unconstrained optimization problem β*=arg max_{β}z_{DC,SMF}. This can be solved numerically using Newton's method, which is a known method but one that has not been used before in this context.

In order to demonstrate the fact that the presently disclosed SMF strategy (10) generates near optimal results, we consider a frequency selective channel whose frequency response is given by FIG. 2 (top), a transmit power of −20 dBm, N=16 sinewaves centered around 5.18 GHz with a frequency gap fixed as Δ_{f}=B/N and B=10 MHz. Assuming such a channel realization, we compare in FIG. 2 (bottom) the magnitudes of the SMF waveform (with β=1, 3) and of the optimum (OPT) waveform obtained using the Reverse GP algorithm derived in [2], [3]. The OPT waveform has a tendency to allocate more power to frequencies exhibiting larger channel gains. Choosing β=1 would allocate power proportionally to the channel strength but has a tendency to underestimate the power to be allocated to strong channels and overestimate the power to be allocated to weak channels. On the other hand, suitably choosing β>1 better emphasizes the strong channels and de-emphasizes the weak channels.

### D. Performance Evaluations

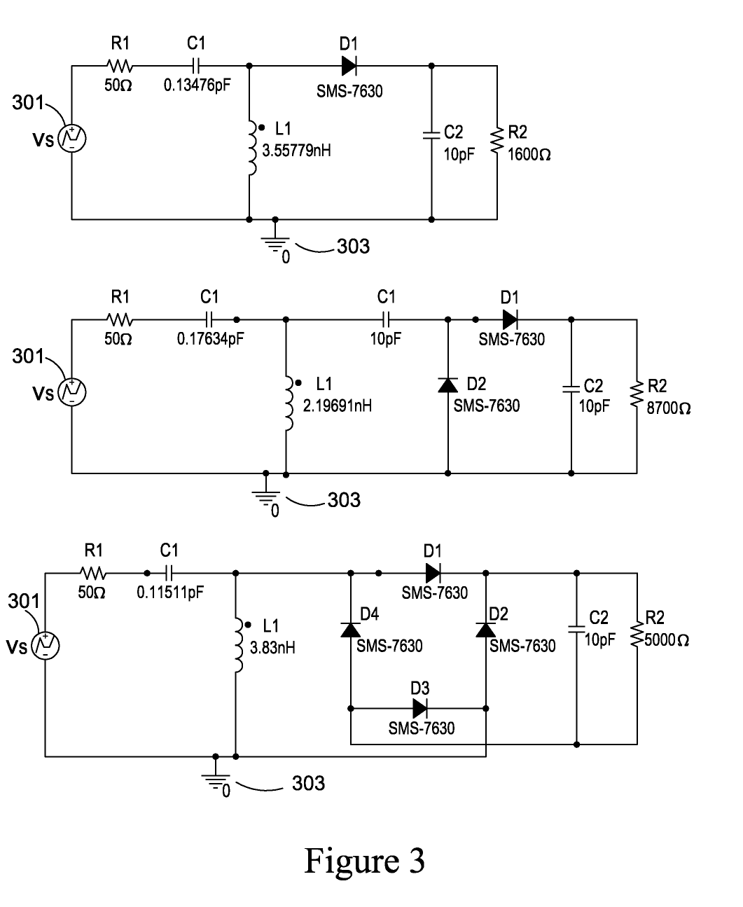

In this section, we evaluate the performance of the waveforms using the rectifier configurations of FIG. 3.

The rectenna designs are optimized for a multisine input signal composed of 4 sinewaves centered around 5.18 GHz with the bandwidth of 10 MHz. The available RF power is P_{in,av}=20 dBm. The components are assumed to be ideal. The input impedance of the rectifier Z_{rect} is dominated by the diode impedance, which changes depending on the input power and the operating frequency. In order to avoid power losses due to impedance mismatch, the matching network design procedure is adapted for a multisine input signal of varying instantaneous power. The matching is done by iterative measurements of Z_{rect} at the 4 sinewave frequencies using circuit simulations and performing conjugate matching of average Z̅_{rect} to Rₐₙₜ=50Ω at each iteration until the impedance mismatch error is minimized. The matching network is also optimized intermittently with the load resistor. The obtained circuits for the single series diode rectifier, voltage doubler and diode bridge rectifier are shown in FIG. 3, where R1 and R2 are resistors, C1-C3 are capacitors, D1-D4 are diodes and L1 is an inductor. Each circuit has a voltage source (301) and a ground point (303).

The performance of WPT waveforms is evaluated in a point-to-point scenario representative of a WiFi-like environment at a center frequency of 5.18 GHz with a 36 dBm transmit power, isotropic transmit antennas (i.e. EIRP of 36 dBm), 2 dBi receive antenna gain and 58 dB path loss in a large open space environment with a NLOS channel power delay profile obtained from model B as described in J. Medbo, P. Schramm, “Channel Models for HIPERLAN/2 in Different Indoor Scenarios,” 3ERI085B, ETSI EP BRAN ([5] henceforth). Taps are modeled as i.i.d. circularly symmetric complex Gaussian random variables and normalized such that the average received power is −20 dBm. The frequency gap is fixed as Δ_{f}=B/N and B=10 MHz. The N sinewaves are centered around 5.18 GHz.

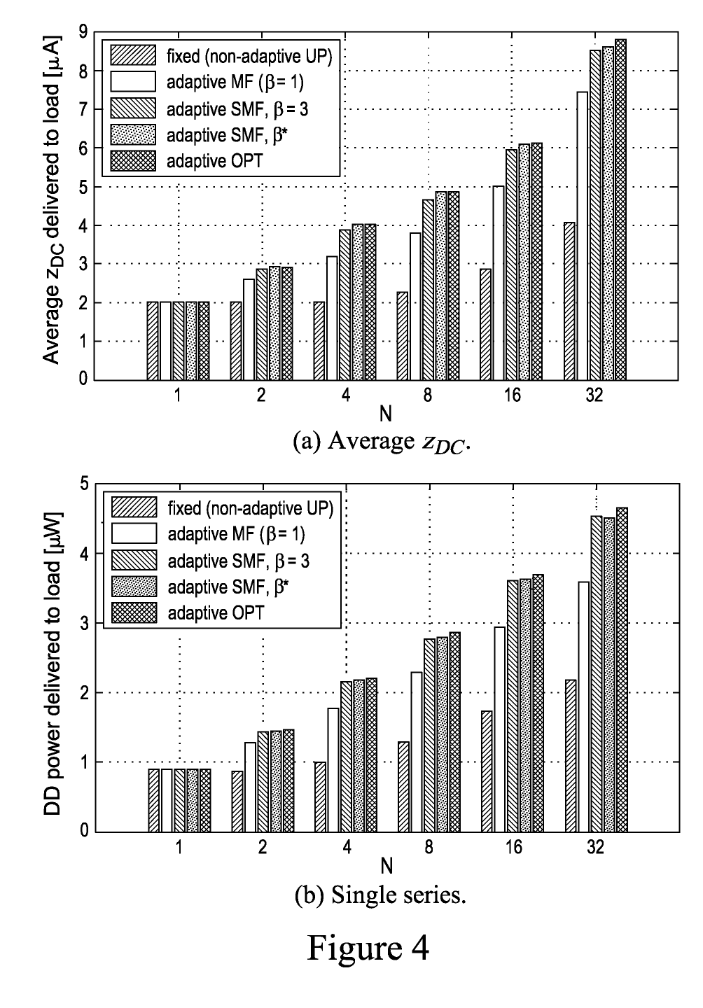

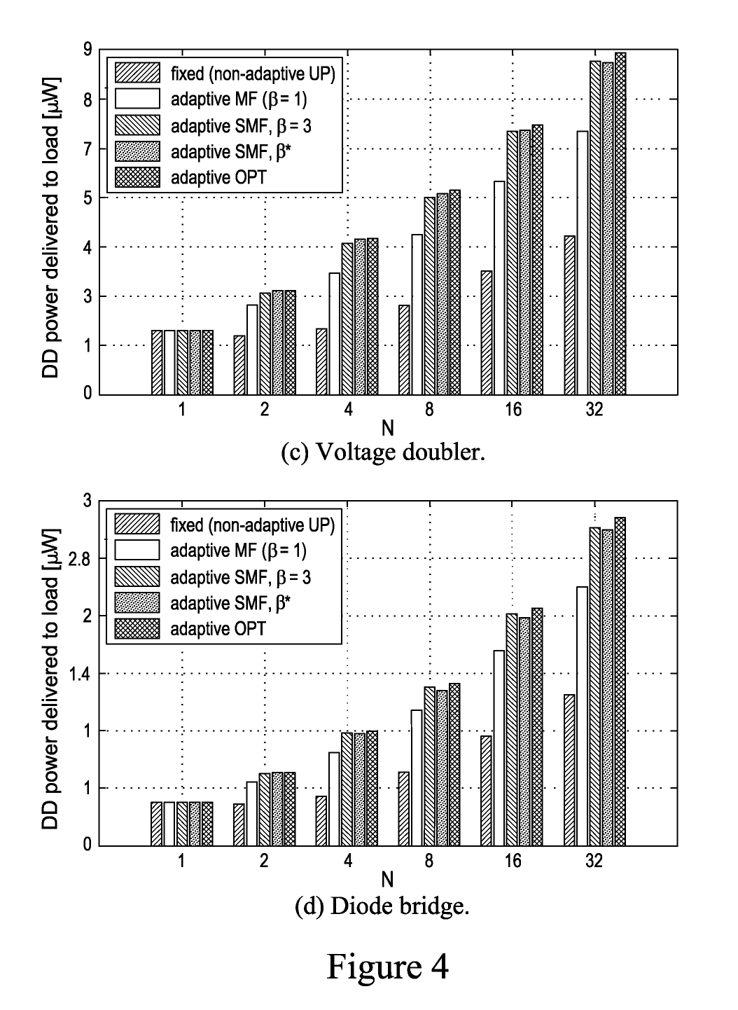

In FIG. 4(a), we display z_{DC} averaged over many channel realizations for various waveforms. The fixed waveform is not adaptive to CSI and is obtained by allocating power uniformly (UP) across sinewaves and fixing the phases φₙ as 0. Adaptive MF is a particular case of the proposed SMF with β=1. SMF with β* refers to the SMF waveform where β is optimized on each channel realization using the Newton's method. Adaptive OPT is the optimal strategy resulting from the reversed GP algorithm derived in [2], [3]. We note that the proposed waveform strategy SMF with β=3 comes very close to the optimal performance but incurs a significantly lower complexity.

In FIG. 4(b)(c)(d), we evaluate the waveform performance using simulation software, in this case PSpice simulations. To that end, the waveforms after the wireless channel have been used as inputs to the rectennas of FIG. 3 and the DC power delivered to the load has been observed. The average DC power, where averaging is done over many realizations of the wireless channels, is displayed in FIG. 4(b)(c)(d) as a function of N. We confirm the observations made using the z_{DC} metric in FIG. 4(a), namely that the performance of SMF with β=3 or β* is very close to that of OPT despite the much lower design complexity. The PSpice evaluations also confirm the benefits of the SMF and OPT waveforms over the conventional non-adaptive UP multisine waveform and the usefulness of the waveform design methodology of [3] in a wide range of rectifier configurations. Results also highlight the importance of efficient waveform design for WPT. Taking for instance FIG. 4(b), we note that the RF-to-DC conversion efficiency jumps from less than 10% to over 45% by making use of 32 sinewaves rather than a single sinewave. We also note that at low average input power, a single series rectifier is preferable over the voltage doubler or diode bridge, which is inline with observations made in A. Boaventura, A. Collado, N. B. Carvalho, A. Georgiadis, “Optimum behavior: wireless power transmission system design through behavioral models and efficient synthesis techniques”, IEEE Microwave Magazine, vol. 14, no. 2, pp. 26-35, March/April 2013.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

The disclosure concerns a WPT link optimization and discloses a method for designing low-complexity multisine waveforms for WPT. Assuming the CSI is available to the transmitter, the waveforms are expressed as a scaled matched filter and shown through realistic simulations to achieve performance very close to the optimal waveforms that would result from a non-convex posynomial maximization problem. Given the low complexity of the design, the proposed waveforms are very suitable for practical implementation.

1. A method of transmitting a multicarrier signal comprising N carriers from at least one transmitter to at least one rectenna in a Wireless Power Transfer (WPT) system, the method comprising:
generating the multicarrier signal for transmission by the at least one transmitter, wherein the generating the signal comprises:
specifying an amplitude, sₙ, of an nₜₕ carrier of the N carriers, wherein the amplitude, sₙ, of the nₜₕ carrier is specified based on a frequency response of a channel associated with the nₜₕ carrier; and
transmitting the signal.

2. The method of claim 1, wherein the amplitude, sₙ, of the nₜₕ carrier is proportional to the frequency response of the channel associated with the nₜₕ carrier.

3. The method of claim 1, wherein the amplitude, sₙ, of the nₜₕ carrier is proportional to the frequency response of the channel associated with the nₜₕ carrier scaled by an exponent factor.

4. The method of claim 3, wherein the exponent factor is a pre-determined constant.

5. The method of claim 3, wherein the exponent factor is selected from a range of values greater than or equal to 0.5 and, optionally, wherein the exponent factor is selected from a range of values greater than or equal to 1.

6. The method of claim 3, wherein the exponent factor is selected from a range of values between 0.5 or more and 5 or less and, optionally, wherein the exponent factor is selected from a range of values between 1 or more and 3 or less.

7. The method of any of claim 3, wherein the amplitude, sₙ, of the nₜₕ carrier is specified in accordance with:
sₙ=cAₙ^{β}
where c is a constant, β is the exponent factor and Aₙ is a magnitude of the frequency response of a channel associated with the nₜₕ carrier.

8. The method of claim 7, wherein
β=argmax_{β}z_{DC},SMF
where argmax_{β}z_{DC},SMF denotes an argument that maximizes z_{DC},SMF.

9. The method of claim 7, wherein c satisfies a transmit power constraint given by:
½Σₙ₌₀^{N-1}sₙ²=P
where P is the transmit power.

10. The method of claim 7, wherein β is fixed or optimized on a per channel basis.

11. The method of claim 1, wherein the multicarrier signal comprising N carriers is transmitted from a plurality of transmitters, wherein the plurality of transmitters optionally comprises a plurality of antennas.

12. The method of claim 1, wherein the multicarrier signal comprises a multisine signal comprising N sinewaves.

13. A Wireless Power Transfer (WPT) system comprising: at least one transmitter for transmitting signals to at least one rectenna, the at least one transmitter comprising a processing environment configured to perform the method of claim 1.

14. The Wireless Power Transfer (WPT) system of claim 13, wherein the transmitter comprises a plurality of transmitters, wherein the plurality of transmitters optionally comprises a plurality of antennas.
